(19) United States
(12) Patent Application Publication
(10) Pub. No.: US 2007/0297105 A1
(43) Pub. Date: Dec. 27, 2007

(54) Active ESD Protection

(76) Inventors: Ciaran J. Brennan, Essex, VT (US); Shunhua T. Chang, South Burlington, VT (US)

Correspondence Address: HOFFMAN, WARNICK & D'ALESSANDRO LLC, 75 STATE ST, 14TH FLOOR, ALBANY, NY, 12207, US

(21) Appl. No.: 11/426,021

(22) Filed: Jun. 23, 2006

(51) Int. Cl. H02H 9/00

(52) U.S. Cl. 361/56

(57) ABSTRACT

A system and method of electrostatic discharge (ESD) protection in a logic circuit using either state manipulation or current injection. A first system is disclosed that includes an ESD detection circuit for detecting an ESD event; and an ESD control circuit that can change a state of the logic circuit from a normal mode to an ESD mode in response to a signal received from the ESD detection circuit. A second system is disclosed that includes an attenuator circuit coupled to a chip pad; and a switch for diverting current from the attenuator circuit to an internal node of the logic circuit during an ESD event to reduce a voltage at the chip pad.

### FIELD OF THE INVENTION

The invention relates generally to providing electrostatic discharge (ESD) protection to integrated circuit devices, and more particularly relates to a system and method of providing active ESD protection using state manipulation and current injection.

### BACKGROUND OF THE INVENTION

ESD, or electrostatic discharge refers to the usually sudden transfer of an ESD voltage potential from one object to another with a lower potential either by inductance or direct contact. ESD protection refers to a system of protecting an integrated circuit from ESD events.

Standard ESD protection depends primarily on simple semiconductor devices (e.g., diodes or snapback n-type field effect transistors (NFETs)) to conduct ESD current safely to the power supply networks. The primary characteristic of a good ESD device is a low voltage drop in the conducting mode. If the ESD current produces a voltage on the chip pad that exceeds the breakdown voltage of circuits or devices connected to the pad, then an ESD failure may occur. The ESD device protects the chip by conducting the ESD current with a low enough voltage drop so that no circuits or devices are damaged.

The failure voltages of complimentary metal-oxide semiconductor (CMOS) devices are decreasing with each generation of technology. The reduction in failure voltages is directly related to decreasing gate oxide thickness and decreasing channel length of the CMOS FET devices. However, the standards for ESD protection are not decreasing. This means that the same level of ESD discharge current must be conducted with a lower voltage drop in each successive technology. Because the performance of the ESD devices is not scaling as fast as the breakdown voltages are decreasing, it is getting harder for each technology generation to achieve the necessary level of ESD protection. Typical solutions that have been implemented involve providing larger ESD devices with lower impedance and lower resistance wiring in the ESD circuit. Larger ESD devices have the disadvantage of consuming greater chip area and adding capacitance to the chip pad, which impairs high frequency performance. Using wider wires to achieve lower resistance wiring has the disadvantage of restricting floorplanning of the input/output (IO) and reducing signal wireability, both of which may increase chip area.

In the conventional ESD protection technology, the circuit to be protected is treated as a passive element. No consideration is given to the internal voltages or logic state of the circuit beyond considering voltages or currents that could damage the circuit. However, the circuit to be protected is often powered by the ESD current flowing into the power supply nets, which can charge up these nets and turn on all the circuits connected to the power net. No attempt to control the state of the circuit to be protected is made and the circuit will power up to an arbitrary state.

### SUMMARY OF THE INVENTION

The present invention addresses the above-mentioned problems, as well as others, by providing a system and method for providing active ESD protection of a logic circuit utilizing state manipulation and/or current injection.

In analyzing the problems described above, it has been observed that the state of the circuit when it is powered up by an ESD event can affect the failure point of the circuit. Certain states will increase the failure voltage by causing the voltage on the chip pad to be distributed among several devices in series, so that the voltage stress on each is reduced. Certain other states will increase the failure voltage by increasing the conduction voltage of the devices under stress. Other states lower the failure point by causing the voltage on the chip pad to be imposed on one or fewer devices, so that the voltage stress on affected devices is increased.

These observations suggest that it is possible to improve the ESD protection of integrated circuits by deliberately manipulating the state and internal voltages of the circuit to be protected when it is powered up by an ESD discharge. An advantage of this approach is that it can provide additional ESD protection without either increasing the size of the ESD devices or decreasing the resistance of the circuit wiring. In other words, deliberately manipulating the state and internal voltages of the circuit can provide increased ESD protection without the disadvantages of significant increases in chip area, impacts to floorplanning, flexibility and wireability, or reductions to high frequency performance of the circuits.

In a first aspect, the invention provides a method of providing active electrostatic discharge (ESD) protection, comprising: providing an ESD detection circuit for detecting an ESD event; providing an ESD control circuit that is configured to change a state of a circuit being protected from a normal mode to an ESD mode in response to a signal received from the ESD detection circuit; detecting an ESD event at the ESD detection circuit; and changing the state of the circuit being protected from the normal mode to the ESD mode.

In a second aspect, the invention provides a system for providing active electrostatic discharge (ESD) protection for a logic circuit, comprising: an ESD detection circuit for detecting an ESD event; and an ESD control circuit that can change a state of the logic circuit from a normal mode to an ESD mode in response to a signal received from the ESD detection circuit.

In a third aspect, the invention provides a system for providing active electrostatic discharge (ESD) protection for a logic circuit, comprising: an attenuator circuit coupled to a chip pad; and a switch for diverting current from the attenuator circuit to an internal node of the logic circuit during an ESD event to reduce a voltage across a device connected to the chip pad.

In addition to the features described above, a circuit may be provided to power the ESD control circuit and the circuit to be protected during an ESD event.

### BRIEF DESCRIPTION OF THE DRAWINGS

These and other features of this invention will be more readily understood from the following detailed description of the various aspects of the invention taken in conjunction with the accompanying drawings in which:

FIG. 1A depicts a circuit in which the ESD current conducted to the VDD network by an ESD diode is used to power the circuit to be protected in accordance with an embodiment of the present invention.

FIG. 1B depicts a circuit in which the ESD current passing through an attenuator and a power switch is used to power the circuit to be protected in accordance with an embodiment of the present invention

FIGS. 2A, 2B, and 2C depict ESD detector circuits in accordance with an embodiment of the present invention.

FIG. 3A depicts a state control system in accordance with an embodiment of the present invention.

FIG. 3B depicts a state control system in accordance with an embodiment of the present invention where the circuits are powered by ESD current flowing through an ESD diode.

FIG. 3C depicts a state control system in accordance with an embodiment of the present invention where the circuits are powered by ESD current flowing through an attenuator and a power switch.

FIG. 4 depicts a differential output circuit having state control in accordance with an embodiment of the present invention.

FIG. 5 depicts a current injection system in accordance with an embodiment of the present invention.

FIGS. 6A and 6B depict differential output circuits having current injection in accordance with an embodiment of the present invention.

### DETAILED DESCRIPTION

This disclosure provide two different approaches for providing active ESD protection, which include: (1) State Manipulation, in which the circuit to be protected is put into a predefined state during an ESD event to improve its ESD robustness; and (2) Current Injection, in which ESD current from the pad is intentionally injected into internal circuit nodes to raise their potential in order to achieve optimal voltage sharing across devices in the circuit. One or both could be utilized within an integrated circuit to provide ESD protection.

### I. State Manipulation

The use of state manipulation for providing ESD protection may be summarized as follows. First, a circuit is provided that is powered up by a portion of the ESD discharge current. Second, an ESD detector circuit is provided to detect an ESD event. Third, the circuit to be protected is placed into a predefined state by control circuits responding to the ESD detector. Fourth, the predefined state is implemented such that the circuit elements are best able to withstand the ESD stress

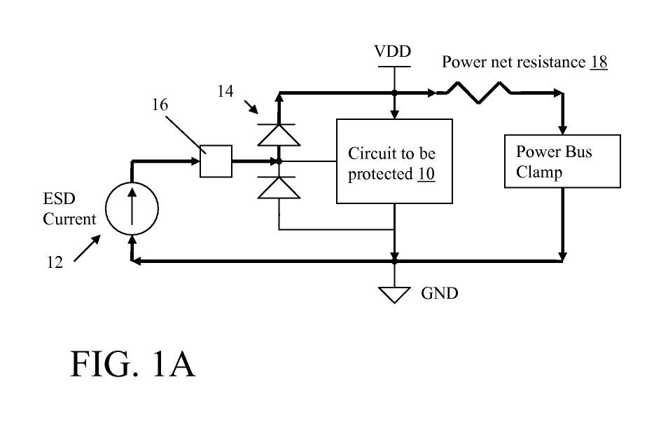

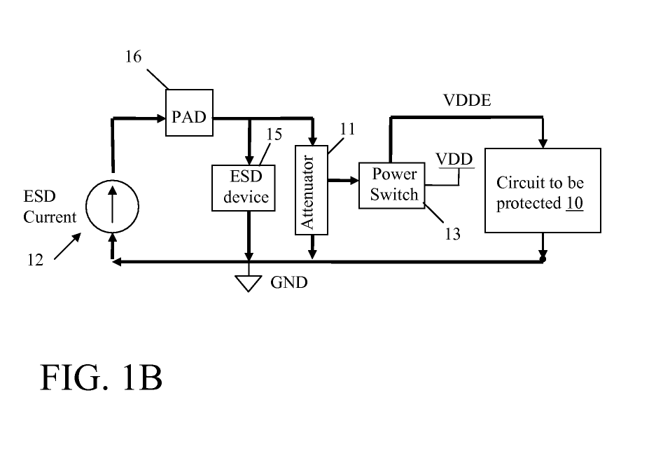

FIG. 1A depicts an illustrative schematic in which the circuit to be protected 10 is powered up by a portion of the ESD current 12 that is discharged during an ESD event. In this case, ESD current 12 flows through an ESD diode 14 on the chip pad 16 to a power supply net (with power net resistance 18), thereby charging the circuit to be protected 10. Obviously, the schematic of FIG. 1A is but one example of such an implementation. Other examples may include: an ESD current 12 that flows through a parasitic diode such as the drain to an Nwell junction on a PFET connected to the chip pad; an ESD current 12 that flows through a diode specifically included to power the circuit during an ESD event; etc.

FIG. 1B depicts an illustrative schematic in which the circuit to be protected 10 is powered up by a portion of the ESD current 12 that has been supplied by an attenuator circuit 11 and a power switch circuit 13. The attenuator circuit 11 reduces the amplitude of the voltage on the pad 16 during the ESD event to a safe level to power the circuit to be protected 10, while ESD device 15 conducts most of the ESD current to the ground net GND. The power switch circuit 13 provides power to the circuit to be protected 10 from the attenuator circuit 11 during an ESD event and from the chip power supply VDD during normal operation. Obviously, the schematic of FIG. 1B is but one example of such an implementation.

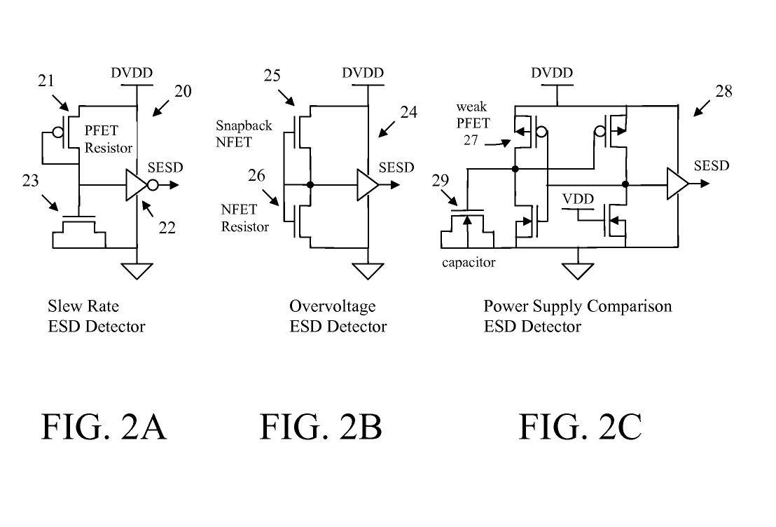

FIGS. 2A, 2B, 2C depict illustrative ESD detector circuits 20, 24, 28 that can be utilized in a state manipulation system. Each such ESD detector circuit is powered up by the ESD event as described above, and outputs a binary state, e.g., “1” in the presence of an ESD event. In each of the cases, the ESD current is detected at node DVDD which causes a sensed ESD signal to be output at the node labeled SESD. It should be understood that ESD detector circuits 20, 24, 28 are meant to depict illustrative detector circuits, and as such, the invention is not limited to the ones depicted herein.

FIG. 2A depicts a slew rate detector 20, in which an R-C network detects the rapid rise of DVDD, e.g., the pad voltage or the power supply, during the ESD event. The PFET resistor 21 and MOS capacitor 23 create an R-C delay that hold the input of inverter 22 low during a rapid rise of DVDD, resulting in a momentary output “1” of inverter 22.

FIG. 2B depicts an overvoltage ESD detector 24, in which a voltage comparator detects a voltage excursion exceeding the maximum allowed operating conditions. Namely, overvoltage ESD detector 24 will output a “1” at SESD when the trigger voltage on the snapback NFET 25 is exceeded.

FIG. 2C depicts a power supply comparison circuit 28, which outputs a “1” if another power supply on the chip is at ground (GND) potential. This occurs when DVDD is turned on suddenly while VDD is at ground potential. This circuit works on the principal that ESD current only charges one power supply at a time in certain ESD protection topologies. For example, an ESD detector circuit powered by an I/O power supply might use core logic VDD as a reference, and output a “1” if the I/O power supply was powered and core VDD was at GND. Power supply comparison circuit 28 contains a latch circuit which is unbalanced by weak PFET 27 and MOS capacitor 29. These elements create an R-C delay that sets the latch and ensures that the power supply comparison circuit 28 will output a “1” when DVDD is high and VDD is low.

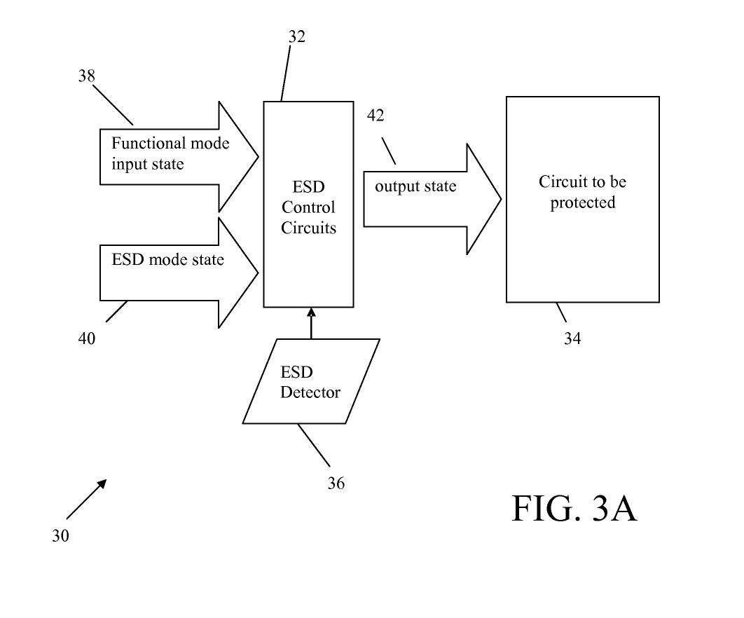

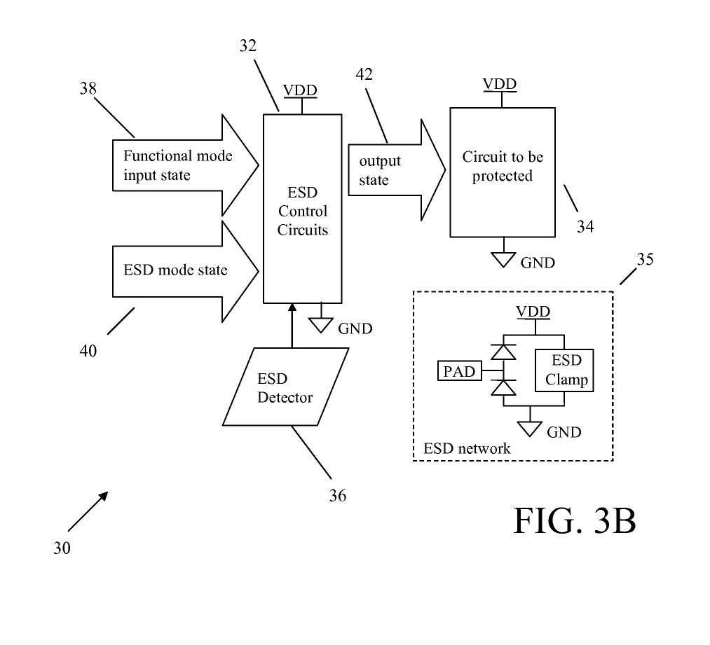

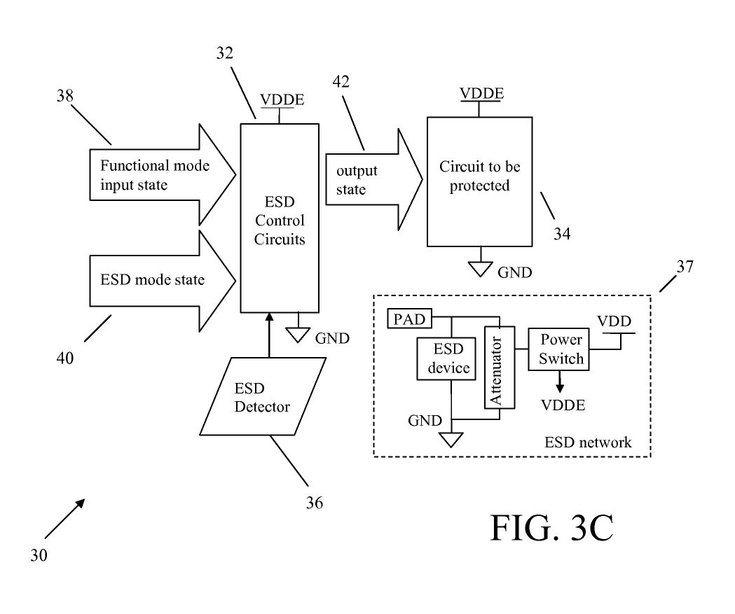

FIGS. 3A, 3B, and 3C depict variations of a state control system 30 in which ESD control circuits 32 are provided to control the state 42 of the circuit to be protected 34. ESD control circuits 32 respond to ESD Detector 36 and generate control signals to change the output state 42 whenever an ESD event is detected. ESD control circuits 32 may include, e.g., logic gates, digital or analog multiplexers, pass gates, transmission gates, diodes or switches. The purpose of these control signals is to switch the circuit to be protected 34 from its normal operation, i.e., functional mode input state 38, to a configuration to optimize ESD robustness, i.e., ESD mode state 40. In a CMOS circuit this may for example consist of forcing certain gates high and others low during an ESD event to turn circuit FETs on and others off. During normal operation, the gates of the same FETs will be controlled by the functional circuits in a normal manner.

FIG. 3B shows the state control system 30 illustrated by FIG. 3A when powered by an ESD network 35 that consists of ESD diodes and ESD clamps on the power supply VDD. FIG. 3C shows the state control system 30 illustrated by FIG. 3A when powered by an ESD network 37 that contains an attenuator circuit and a power switch circuit to power the circuit to be protected during an ESD event.

ESD mode state 40 is implemented such that the circuit elements in the circuit to be protected 34 are best able to withstand the ESD stress. The ability of a CMOS circuit to withstand an ESD stress can be dependent on the state of the circuit, that is, which FETs are on and which are off. Several of the effects that may influence ESD robustness are noted below.

CMOS FETs have a higher drain to source snapback trigger voltage Vt1 when in the off state (Vgs<Vt) than when in the on state (Vgs>Vt). Silicided FETs in most CMOS processes cannot withstand snapback and should be kept off to increase their snapback voltage. Non-silicided FETs, on the other hand, may be able to withstand considerable snapback current, and generally have improved ESD performance in the on state.

Stacked or cascaded output FETs have improved tolerance to drain-source overstress voltage compared to single FETs. Their ESD robustness is maximized when both devices are turned off. Any leakage current of the topmost FET during the ESD event will elevate its source potential relative to its gate potential. This creates a negative gate to source bias that will further increase the snapback voltage of the stacked NFETs.

Differential output NFETs will have a higher breakdown voltage if the common mode current source NFET is in the off state. This will ensure that the output NFETs are not conducting, as conduction will lower their snapback trigger voltage Vt1. Keeping the gate voltage of both output NFETs at ground potential will further increase the snapback voltage of the output circuit, which in turn increases the voltage at which ESD failure will occur.

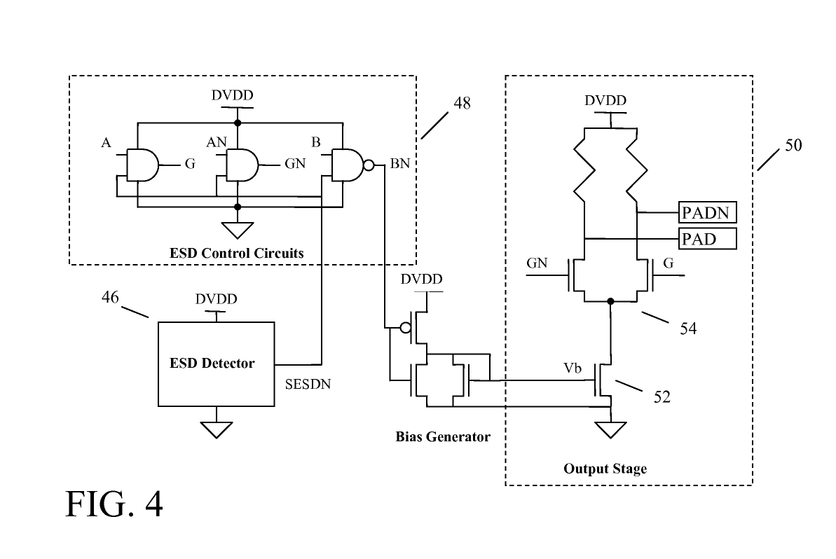

FIG. 4 depicts an example of a differential output circuit 50 whose state is controlled by ESD control circuits 48 in response to a signal received from ESD detector 46. During an ESD event, DVDD is charged by ESD current. In this illustrative configuration, ESD detector 46 outputs a “0” at the SESDN node during the ESD event. In response to this signal that an ESD event has occurred, ESD control circuits 48 force nodes G and GN low and BN high. This in turn changes the state of differential output circuit 50 by turning off output current source NFET 52 and grounding the gates of output NFETs 54. This raises the snapback voltage Vt1 of the output circuit, which allows the differential output circuit 50 to better handle the ESD event.

### II. Current Injection

The use of current injection for providing ESD protection may be summarized as follows. First, a voltage attenuator circuit is provided to take the voltage generated at the chip pad by the ESD discharge and to generate a reduced voltage for current injection. Second, a switch circuit is provided to turn on in response to an ESD event, wherein the switch circuit conducts current from the voltage attenuator circuit to one or more internal nodes to raise their potential. The voltages on the internal nodes are such that the pad voltage is distributed across multiple devices in the circuit, so that the maximum stress on any one of the elements is reduced.

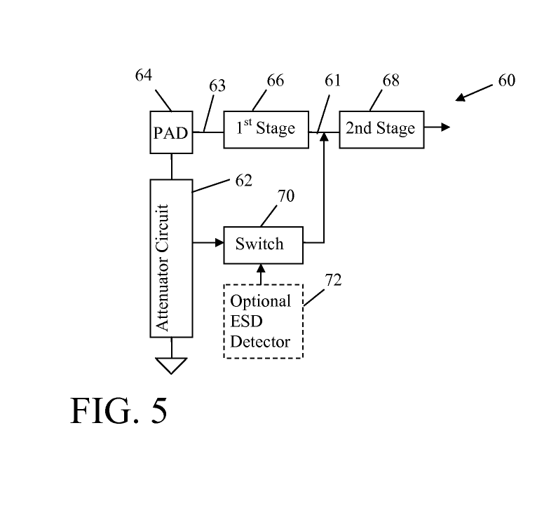

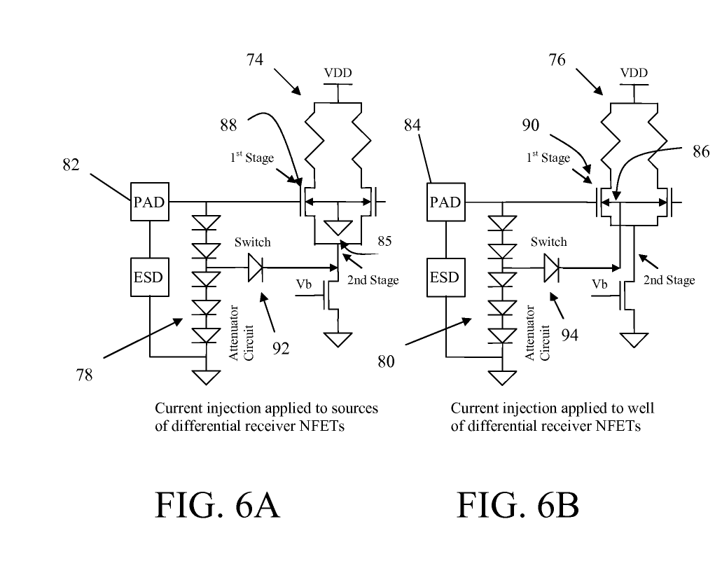

FIG. 5 depicts an overview diagram of a current injection system 60 that provides a voltage attenuator circuit 62 that reduces the voltage generated at chip pad 64 by the ESD discharge. The primary concept of current injection system 60 is to generate an attenuated voltage from pad 64 and inject this voltage into internal nodes through switch 70 during an ESD event, to reduce the voltage drop across a first stage 66 of circuitry and to share the pad voltage across two or more stages 66, 68. Attenuator circuit 62 may for instance comprise a resistive divider; however, this will load pad 64 during normal operation. An alternative solution is to provide a string of diodes (or diode connected bipolars or NFETs) that will not conduct until the pad voltage exceeds normal operating voltages. An example of this configuration is shown in FIGS. 6A and 6B. Once forward biased, diode string 78, 80 acts as a resistive divider to generate the ESD bias voltage. During normal operation, diode string 78, 80 will provide minimal loading on pad 82, 84. It is also possible to use an internal node in an existing ESD diode string as a source of ESD bias voltage.

Referring again to FIG. 5, switch 70 is provided to turn on in response to an ESD event. The purpose of switch 70 is to direct current from attenuator circuit 62 to one or more internal nodes of the circuit to be protected during an ESD event, and block this current flow during normal operation. Switch 70 may be an active circuit such as a pass gate or transmission gate controlled by an optional ESD detector circuit 72. Switch 70 may also be a passive component such as a diode that conducts when forward biased (such as those circuits shown in FIGS. 6A and 6B). Since the voltages generated by attenuator circuit 62 during an ESD event will be much larger than those encountered during normal operation, the passive diode approach may often be adequate. A design goal of switch 70 is to provide effective injection of the ESD current into the circuit to be protected without loading the circuit and decreasing its performance.

As noted, the purpose of switch 70 is to conduct current from voltage attenuator circuit 62 to one or more internal nodes to raise their potential. In the example shown in FIG. 5, the current from voltage attenuator circuit 62 is applied to a node 61 behind circuit node 63 that is directly connected to pad 64. This reduces the voltage drop across this first stage 66 during the ESD event by increasing the voltage at node 61 and spreading it out to the second stage 68. Attenuator circuit 62 must be able to supply enough current to raise the internal node fast enough to respond to the ESD event (e.g., <400 ps). For example, in FIGS. 6A and 6B, the current is injected into either the source nodes 85 (FIG. 6A) or the wells 86 (FIG. 6B) of a differential receiver circuit 74, 76.

By implementing such a configuration, the voltages on the internal nodes are such that the pad voltage is distributed across multiple elements in the circuit (e.g., first stage 66 and second stage 68 of FIG. 5), so that the maximum stress on any one of the elements is reduced. For example, FIGS. 6A and 6B depict current injection ESD protection being applied to differential receivers 74, 76. In both cases, a diode string 78, 80 forms the attenuator circuit. Diode string 78, 80 will be at high impedance during normal operation and will conduct during an ESD stress. Switch 92, 94 is simply another diode that becomes forward biased when diode string 78, 80 conducts. In the circuit of FIG. 6A, the current is injected to common source node 85 of the receiver. The circuit of FIG. 6B differs only in that the current is injected into isolated Pwell 86 of the receiver input NFETs.

In operation, gate 88, 90 of the receiver FET is exposed to the pad voltage. An attenuated voltage from diode string 78, 80 is then applied to source 85 or well 86 of the FET to elevate its potential and reduce the voltage across gate 88, 90 of the FET to safe levels. The pad voltage is thus split between the gate to source (FIG. 6A) or well (FIG. 6B) of the receiver NFET, and the drain to source of the current source NFET.

This technique may also be used on stacked output FETs, with the attenuated voltage applied to a drain of the bottom FET in the stack. Elevating the drain voltage of the bottom FET will reduce the drain to source voltage of the top FET and prevent premature failure.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method of providing active electrostatic discharge (ESD) protection, comprising:
providing an ESD detection circuit for detecting an ESD event;
providing an ESD control circuit configured to change a state of a circuit being protected from a normal mode to an ESD mode in response to a signal received from the ESD detection circuit;
detecting an ESD event at the ESD detection circuit; and
changing the state of the circuit being protected from the normal mode to the ESD mode.

2. The method of claim 1, wherein the ESD detection circuit comprises a slew rate detector.

3. The method of claim 1, wherein the ESD detection circuit comprises an over-voltage detector.

4. The method of claim 1, wherein the ESD detection circuit comprises a power supply comparison circuit.

5. The method of claim 1, wherein the circuit being protected is powered by an ESD discharge current.

6. The method of claim 1, wherein the circuit to be protected comprises a differential output circuit having a pair of output field effect transistors (FETs) and an output current source FET, and wherein the step of changing the state of the differential output circuit comprises:
turning off the output current source FET and the output FETs.

7. The method of claim 1, wherein the circuit to be protected comprises a silicided field effect transistor (FET), and wherein the step of changing the state of the circuit to be protected comprises turning off the silicided FET.

8. A system for providing active electrostatic discharge (ESD) protection for a logic circuit, comprising:
an ESD detection circuit for detecting an ESD event; and
an ESD control circuit that can change a state of the logic circuit from a normal mode to an ESD mode in response to a signal received from the ESD detection circuit.

9. The system of claim 8, wherein the ESD detection circuit comprises a slew rate detector.

10. The system of claim 8, wherein the ESD detection circuit comprises an over-voltage detector.

11. The system of claim 8, wherein the ESD detection circuit comprises a power supply comparison circuit.

12. The system of claim 8, wherein the logic circuit is powered by an ESD discharge current.

13. The system of claim 8, wherein the logic circuit comprises a differential output circuit having a pair of output field effect transistors (FETs) and an output current source FET, and wherein the ESD control circuit changes the state of the differential output circuit by turning off the output current source FET raising a gate voltage of the output FETs.

14. The system of claim 8, wherein the logic circuit comprises a silicided field effect transistor (FET), and wherein the ESD control circuit changes the state of the logic circuit by turning off the silicided FET.

15. A system for providing active electrostatic discharge (ESD) protection for a logic circuit, comprising:
an attenuator circuit coupled to a chip pad; and
a switch for diverting current from the attenuator circuit to an internal node of the logic circuit during an ESD event to reduce a voltage across a device connected to the chip pad.

16. The system of claim 15, wherein the attenuator circuit comprises a diode string.

17. The system of claim 16, wherein the switch comprises a diode coupled to the diode string.

18. The system of claim 15, further comprising an ESD detector circuit for detecting an ESD event.

19. The system of claim 15, wherein the current is diverted to a node in the logic circuit that is separated from the chip pad by at least one circuit element.

20. The system of claim 15, wherein the logic circuit comprises a differential receiver having a receiver input field effect transistor (FET) whose gate is coupled to the chip pad, and wherein the attenuator circuit diverts current from the chip pad to one: a common source node of the differential receiver and an isolated well of the receiver input FET.
